(19) United States
(12) Patent Application Publication
(10) Pub. No.: US 2003/0154127 A1
(43) Pub. Date: Aug. 14, 2003

(54) Manufacturer incentive system

(76) Inventors: Barry S. McAuliffe, San Jose, CA (US); David A. House, Palm Beach Gardens, FL (US); Benjamin J. Weisshaut, Mill Valley, CA (US); Jeffrey G. Ichnowski, Palo Alto, CA (US)

Correspondence Address: Howard R. Boyle, TROP, PRUNER & HU, P.C., Suite 100, 8554 Katy Freeway, Houston, TX, 77024-1841, US

(21) Appl. No.: 10/074,386

(22) Filed: Feb. 12, 2002

(51) Int. Cl. G06F 17/60

(52) U.S. Cl. 705/14; 705/37

(57) ABSTRACT

A method and apparatus is disclosed for tracking the buying and selling of a manufacturer's goods or products where the manufacturer may receive an incentive from the sale of the manufacturer's goods or products by other sellers. A manufacturer may have one or more incentive programs that may apply to goods sold or otherwise transferred. The method and apparatus may determine the incentive program that may apply and determine the incentive due the manufacturer.

### FIELD OF THE INVENTION

This invention relates to tracking transactions between buyers and sellers of a manufacturers' goods and products where an incentive may be paid to the manufacturer.

### BACKGROUND

Current markets for buying and selling excess, new, used or refurbished goods, parts or products are typically highly fragmented and inefficient. Frequently the primary means for such transactions is, what may be referred to as, the “gray market” that may result in manufacturers losing revenue and profits because their products may be sold outside channels of commerce authorized by the manufacturer, and because the sales of the manufacturer's products through the gray market may actually compete with sales of the same product from the manufacturer's own sales, goods or inventory. The gray market is one example of a secondary market where a secondary market may be an alternative market to the manufacturer's distribution chain.

FIG. 6 illustrates a prior art distribution system. A manufacturer 501 may sell products to its customers 703. Customers 703 may be any direct buyer of goods from the manufacturer 501. The customers 703 may sell or otherwise distribute the manufacturer's 501 goods into the gray or other secondary market 705.

The gray market may be defined as the distribution of a manufacturer's product outside the manufacturer's authorized distribution channels. However authorized distribution channels may utilize and participate in gray market sales and marketing activities. Products on the gray market may be shopped globally and may frequently move through multiple tiers of sellers before reaching an end user. Products may flow into the gray market in various ways. For example, product may be sold outside of its intended geography. This diversion of a manufacturer's product may increase the likelihood that customers will receive product that has been damaged or tampered with and therefore may create customer dissatisfaction with the manufacturer and loss of the manufacturers' good will.

In addition to customer issues, manufacturers may lose revenue and profit through the operation of the gray market because excess inventory of their product may be procured from the manufacturer's distributor or customer at an extremely low price by brokers and then resold through the gray market at lower prices than those at which the manufacturer may offer the product. Thus, the manufacturer may lose revenue and profit when excess inventory of its product is resold in competition with the same product from the manufacturer, because of the generally lower prices on the gray market.

As another example of a gray market issue, a product shortage may occur where the manufacturer cannot supply product to its customer. During this product shortage the customer may be compelled and sometime forced to buy product from an alternative channel. Again one such channel would be the gray market or other secondary market. In the example a broker may take advantage of a buyer of the goods and in many cases may mark the price higher than the normal manufacturer's pricing.

Brokers that may trade in the manufacturer's goods in the gray market may obtain a manufacturer's product in ways besides excess inventory from the manufacturer's end user customer. As one example, a manufacturer may authorize resellers to sell only to end customers, and the manufacturer may not authorize brokers. However, gray market brokers attempt to obtain product from all stages of the distribution process, including from resellers, not merely from an end user's excess inventory. The product that brokers obtain, from whatever sources, may be resold multiple times and may be diverted across national borders which could lead to a greater likelihood that the customers will receive damaged or faulty product through the gray market. In addition, this diversion may also result in multiple opportunities for loss of the manufacturer's revenue and profit.

Another example of a secondary market may be private or public auctions and more recently online auctions. In an auction-based market, goods are often being sold outside the manufacturers authorized channels, thus again competing with the manufacturer's sales and revenue. Buyers and sellers go to auctions often believing that they can get better deals than through a traditional sales channel. Traditionally auction models, online or otherwise, do not provide an incentive to the original manufacturer of the goods being sold unless the manufacturer is the seller.

Stated another way, manufacturers worldwide have been limited to only a few revenue and profit channels for their goods. These channels include, but are not limited to, the following channels: direct sales, distributors, value added resellers, retail, e-commerce, and auctions, online or traditional. Of the above channels the product manufacturers may typically receive a payment or profit for a specific product sold only one time, with later resale's of the product actually competing with the same products from the manufacturer.

Therefore manufactures need a way to receive revenue or other compensation from the sales of products in the gray and other alternative markets to ensure a fair return on the manufacturing investment. In addition, manufactures need a way to assist customers in receiving quality products to protect the manufacturer's customer good will.

### BRIEF DESCRIPTION OF THE DRAWINGS

The present invention may be better understood with reference to the drawings that are intended to illustrate only examples of embodiments of the invention and are not to be considered to limit the scope of the invention. The invention may well admit of equally effective additional embodiments without departing from its scope.

FIG. 1 illustrates an Imarket according to embodiments of the present invention.

FIG. 2 is a block diagram of product, information and incentive flow for an Imarket according to embodiments of the present invention.

FIG. 3 is a block diagram flow chart of an incentive program according to embodiments of the present invention.

FIG. 4 is a block diagram flow chart of an incentive program according to embodiments of the present invention.

FIG. 5 is a block diagram of a data model according to embodiments of the present invention.

FIG. 6 is a computer system according to embodiments of the present invention

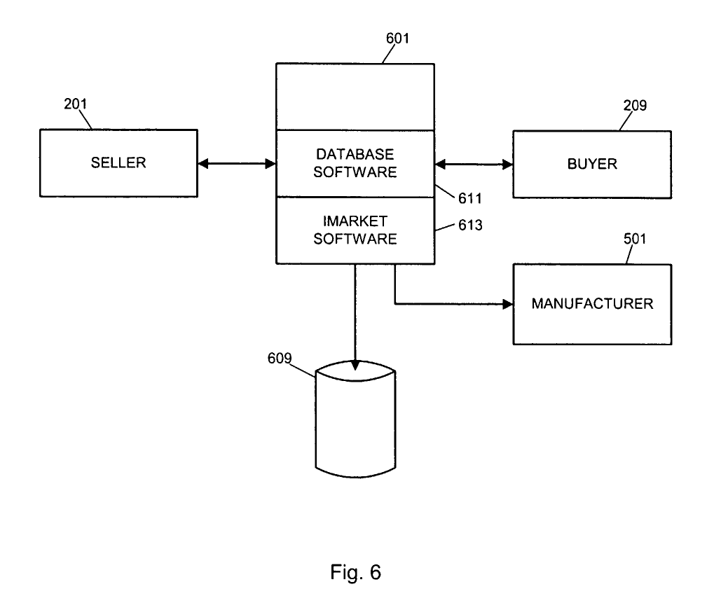

FIG. 7 is a prior art diagram of a distribution network.

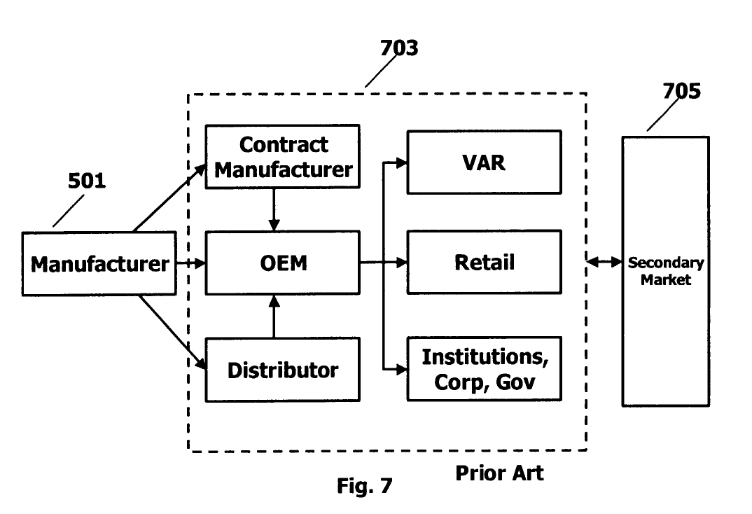

### DETAILED DESCRIPTION OF PREFERRED EMBODIMENTS

In the following detailed description, numerous specific details are set forth in order to provide a thorough understanding of the invention. However it would be understood by those of ordinary skill in the art that the present invention may be practiced without these specific details. In other instances, well known methods, procedures, components and the like have not been described in details so as not to obscure the present invention.

### Manufacturer Incentive Program

Previous gray or other secondary markets for selling products or other goods have not provided profit sharing or other compensation to the original manufacturer for sales after the first sale of the goods or products. These markets have provided sales wherein the original manufacturer receives compensation for sale of a good or product only the first time it is sold and then only if the product is sold by or on behalf of the original manufacturer. As the good or product is resold as, for example, excess inventory, it may be actually sold in competition with new goods or products from that manufacturer. In contrast, in some embodiments of the present invention, a percentage of the revenue or other compensation for each transaction that occurs after the original sale by the manufacturer may be granted to the manufacturer. This revenue or compensation sharing may be an incentive to motivate the manufacturer to use and recommend the use of a system or marketplace utilizing embodiments of the present invention.

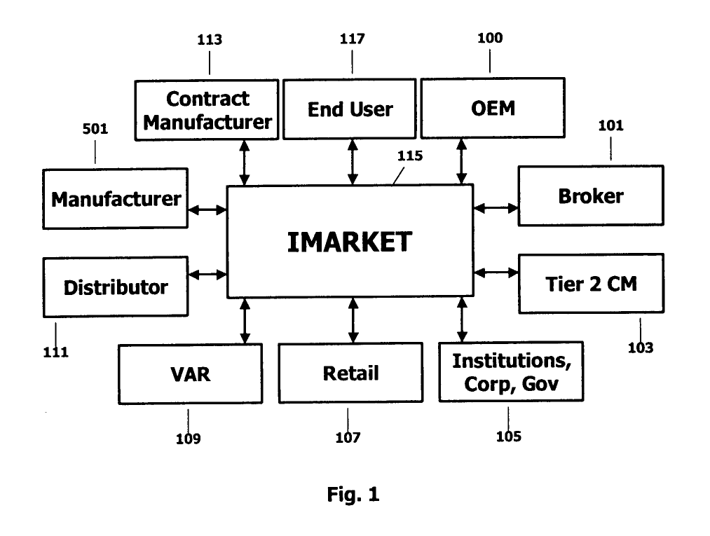

Referring now to FIG. 1, manufacturer 501 along with other sellers of the manufacturer's goods, for example, Original Equipment Manufacturers (OEMs) 100, brokers 101, tier 2 contract manufacturers 103, institutions, corporations or governments 105, retail sellers 107, value added resellers 109, distributors 111, contract manufacturers 113, and end users 117 may sell the manufacturer's goods into an Incentive Market (Imarket) 115. This Imarket 115 may provide an incentive to the manufacturer for goods sold on the Imarket where the seller may not be the manufacturer.

Payments of a share of the revenue or other compensation (incentive) may vary with each manufacturer that participates in this program and may be set at time of engagement, may be determined at some later time, or based on some criteria such as, by way of example only, the volume of sales of the manufacturer's goods on the Imarket. In some embodiments, the amount and type of incentive may vary by each user type.

In some embodiments, the incentive may be different or varied by specific part number, product family, program, annual dollar volume of combined sales and purchases. Incentives may also be based, as two examples, upon percent of the sales revenue or a percent of profits.

### An Incentive Market Place

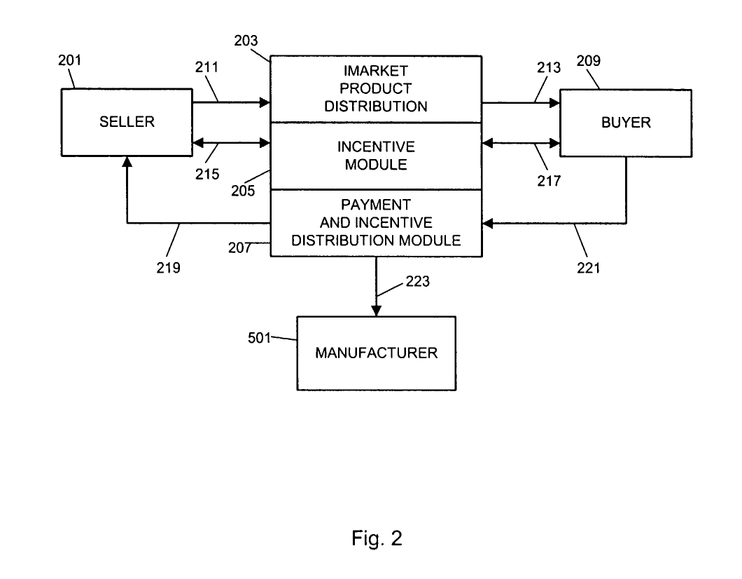

FIG. 2 illustrates an example of how a Manufacturer may be able to allay the effects of the Gray Market or another secondary market and receive an incentive for the manufacturers goods sold on the Imarket 115. The seller of the goods 201 may offer goods manufactured by the manufacturer 501 for sale on the Imarket 115. In some embodiments, the Imarket 115 may include a physical inventory distribution process 203, an incentive module 205 and a payment and incentive distribution module 207. A buyer 209 may buy the goods offered by the seller 201. In some embodiments, the manufacturer 501 may receive an incentive from the purchase by the buyer 209 of the goods offered by the seller 201.

In some embodiments, goods may flow 211 from the seller 201 through a physical inventory distribution process 203. The distribution process may then flow 213 the goods to the buyer 209. The physical inventory process may include a third party to whom the goods are consigned. A third party may be advantageously utilized to conceal the identity of either, or both, the buyer 209 and the seller 201 from each other. In other embodiments, the goods may flow directly from the seller 201 to the buyer 209. Of course, other distributions of the physical goods from the seller 201 to the buyer 209 may be utilized.

A seller may wish to sell goods and may therefore cause a sell offer to be submitted into the Imarket. In some embodiments, the sell offer may be a listing of a product for sale or other indication that the seller wishes to sell a particular product or products. A buyer wishing to purchase the goods offered by the seller may cause a buy order to be submitted. In some embodiments, the buy order may be, in part, an acceptance of the seller's terms or other indication that the buyer wishes to purchase the goods or product for sale. The incentive module 205, in some embodiments, may receive the sell offer 215 from the seller 201 and the buy order 217 from the buyer 209. In other embodiments, the buyer 209 may offer a price for the goods that may then be accepted by the seller 201. In another embodiment, the buyer 209 and the seller 201 may enter into a negotiation of the price for the goods. In still another embodiment, the seller 201 may offer the goods or products for sale by auction. Other interactions between the seller and buyer may also be utilized.

As will be discussed in more detail below, the incentive module 205 may, in some embodiments, notify either or both the seller and buyer that the goods have been sold. In addition, the incentive module 205 may also determine what incentive, if any, the manufacturer 501 of the goods may receive. Of course, the functions performed by modules 205 and 207 may be performed by the same module or split into three or more modules.

The selling information such as, by way of example, the description of the goods, quantity and price may be entered into the incentive module 205 in any convenient manner. For example, the seller may utilize an electronic protocol such as XML, a spreadsheet, word processor document, ASCII file, Electronic Data Interchange (EDI), or RosettaNet as six of many possible methods. In addition, the seller, Imarket host or other entity, may manually enter the data into the incentive module. The Imarket host may directly or indirectly provide the electronic hosting of the Imarket modules such as modules 205 and 207. In addition, the Imarket host, in some embodiments, may also accept consigned goods from sellers and distribute the sold goods to the buyers.

The payment and incentive distribution module 207, in some embodiments, may calculate and and/or distribute the payment 219 due to the seller 201 from buyer 209. The buyer 209 may pay 221 for the goods purchased by any accepted means including, but not limited to, cash, check, electronic transfer, debit of account, purchase order, etc. In addition, the incentive distribution module may distribute the incentive 223 due to the manufacturer 501. While the incentive may be monetary, other incentives, including, but not limited to, cash, check, electronic transfer, credit of account, tax credits, discounts, credit card, etc. may be utilized.

The seller 201 may be any of the sellers of which examples are shown in FIG. 1, 100-113 including the manufacturer 501. Where the manufacturer 501 is the seller 201, an incentive may not apply.

As one possible example of how the Imarket may advantageously operate, manufacturer 501 may sell goods to the contract manufacturer 113. Contract manufacturer 113 now discontinues production, which causes an excess inventory situation for the contract manufacturer 113. The contract manufacturer 113 may then sell the excess inventory through the Imarket 115 to a buyer that may be Tier 2 contract manufacturer 103. The incentive module 205 may then acknowledge the sell of the manufacturer's goods through the market and electronically account for the sale of those goods between the buyer 103 and seller 113. The sale information may then be sent to a database or other program that logs and determines the incentive for the sale due the manufacturer. The manufacturer 501 may receive an incentive for every sale, or subset of sales, that occur for the manufacturer's goods on the Imarket. The specific incentive due the manufacturer may be based of a specific contract or business agreement between the manufacturer and the Imarket host that specifies the terms and conditions of the incentive. In some embodiments, the terms and conditions may specify the number of times a product may be sold and/or what specific goods are eligible for an incentive.

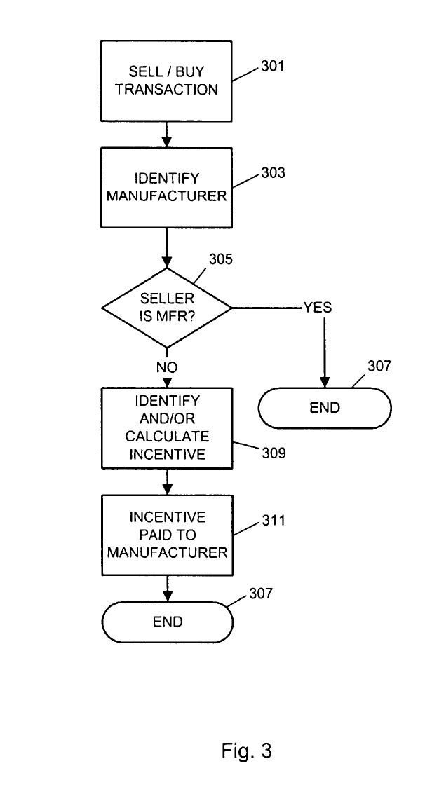

FIG. 3 illustrates by block diagram a flow process that may represent a manufacturer 501 selling to a contract manufacturer 113 via the Imarket marketplace according to embodiments of the present invention. The designation of the Imarket participants as manufacturer and contract manufacturer is merely an example. In this embodiment, as the seller is the manufacturer, the seller obtains its agreed upon price and there is no additional incentive to the manufacturer seller. The manufacturer and buyer enter into a transaction 301 and the transaction may be tracked by appropriate software such as module 205. The appropriate software such as module 205 may determine the manufacturer of the goods 303. If the manufacturer is determined to be the seller 305, the process ends 307 as no incentive is due the seller as the seller is the manufacturer and is compensated by the agreed upon price. Had the seller been other than the manufacturer, the processes represented by blocks 309 and 311 may have been performed as described in detail below.

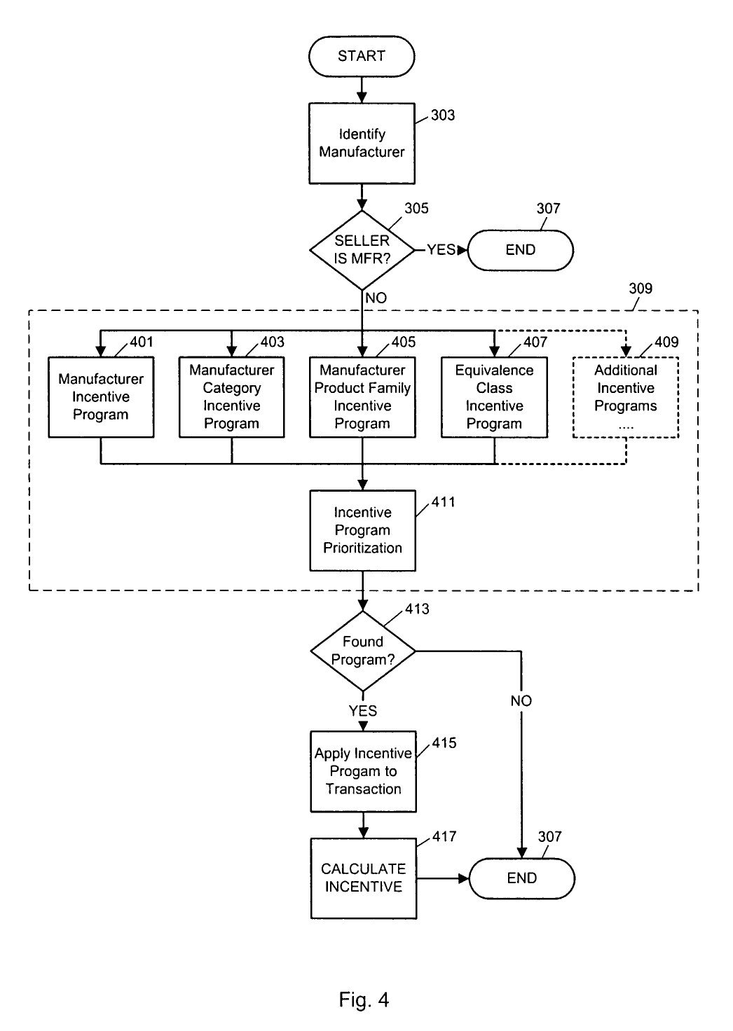

FIG. 4 illustrates by block diagram a flow process of an embodiment of the present invention where, by way of example, a contract manufacturer 113 sells products to a Tier-2 Contract Manufacturer 103 with an incentive, based on the sale of the products, paid to the manufacturer that is not a party to the transaction. In this example, the manufacturer does not itself directly sell its product through the system but receives an incentive fee merely because the product it manufactured was sold by its current owner through the Imarket. This incentive may motivate the manufacturer to use and recommend the marketplace to sell excess inventory or unwanted products. The flow process may be the same as for the example of FIG. 3 except that the seller is determined 305 not to be the manufacturer. Therefore the process flows to block 309 to determine if an incentive program applies to the products sold on the Imarket.

In some embodiments, multiple incentive programs 401-409 may be applicable to a particular manufacturer. In this case, an incentive program prioritization process 411 may select one of the applicable incentive programs. The incentive program selected, if any, may be selected based on a certain criteria such as a product line, a equivalence program, manufacturers incentive program, particular product category incentive program, or other selection criteria. If an incentive program is found that applies to the transaction 413, then, in some embodiments, the terms of the incentive program may be applied to the transaction 415 and an incentive due the manufacturer may be calculated 417 by, for example, module 205. The incentive may then be distributed to the manufacturer. At process block 411, should an incentive program not have been selected because, as one example, a current incentive program did not cover the particular product sold, then no incentive may be due the manufacturer and the process may end 307.

The incentive determined may, in some embodiments, take into account an incentive program that has as inputs the results of prior incentive programs or prior sale transactions. In one embodiment, the incentive calculated for a particular transaction may be determined, in part, by the volume of prior transactions. In another embodiment, the incentive may be determined, in part, by the cumulative total of prior transaction revenue. In still other embodiments, the incentive may be determined, in part, on the type of transaction. For example, the incentive may be different for a transaction where the buyer posts a “wanted” order than for a transaction where the seller posts an offer for sale. Such adjustments may reward a customer or manufacturer for generating a high volume, as one example. Other adjustments of the incentive are also possible and may vary by customer or by manufacturer etc.

The detecting of the incentive programs and other search functions may, in some embodiments, be performed by a search engine that may be associated with a particular data base program that may be utilized to store the transaction or other data. In other embodiments, a specialized search engine may be utilized for this purpose.

### Data Base Organization

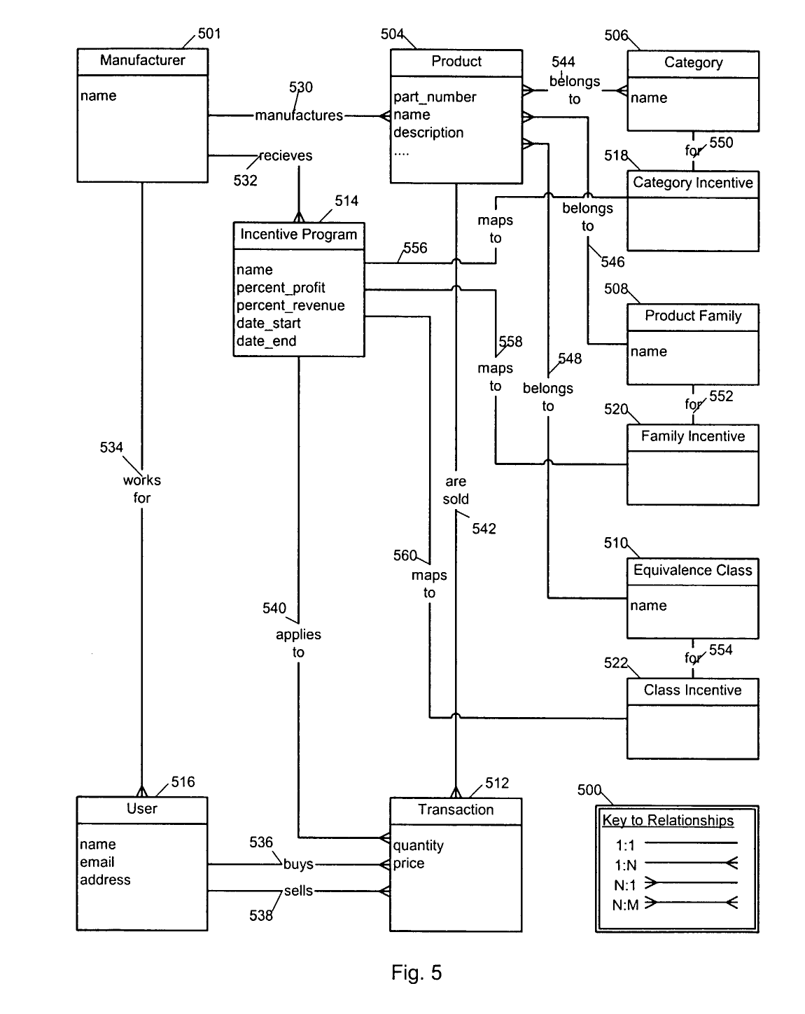

FIG. 5 illustrates an embodiment of the invention showing a data model generally in block diagram form. Each of the boxes may represent a single entity or table, and the key to the relationships in the figure may be seen in box 500. For example, a straight-line connection between boxes in the block diagram may indicate a one-to-one relationship between the tables. The other relationships may be easily understood.

The data model in FIG. 5 in general describes a system of a market for tracking transactions of manufactured goods sold between buyers and sellers. It may utilize additional tables to enable a match between products in transactions and manufacturer incentive programs.

The manufacturer 501 may have manufactured one or more products as may be listed in the Product Table 504. The manufacturer 501 and users 516 may desire to sell units of that product. Category Table 506 may characterize the product as to category, as to product family by the Product Family table 508, and as to product equivalence class by the Equivalence Class table 510. An equivalence class for this example may be a grouping of products that may be used in place of one another. However, more generally it may be any grouping of products by a given name. Transactions may be stored in the Transaction table 512. The incentive program by which the manufacturer receives an incentive, for example, revenue or profits, may be as set forth in the incentive program table 514. The user or users who sell products made by the manufacturer may be indicated in the User table 516.

The matching between product 504 and incentive program 514 may be done through the product characteristics described in category 506, product family 508, and equivalence class 510. The matching between incentive program and product characteristic may be done by category through the Category Incentive table 518, and by product family through the Family Incentive table 520, and by equivalence class through the Class Incentive table 522.

The data model in FIG. 5 may have relationships between the above-described tables. Products 504 are sold 542 in transaction 512. In each transaction 512, a user 516 sells 538 and another user buys 536 the product sold. The relationships 536, 538 and 542 are one-to-many relationships, in that each transaction has exactly one buyer, seller, and product; but each product may be sold in many different transactions, and each buyer and seller may participate in many different transactions.

Each product 504 belongs 544 to zero or more categories 506, and belongs to 546 zero or one product family, and belongs to 548 zero or one equivalence class. Reading the relationships the other way, each category may have zero or more products, each product family may have zero or more products, and each equivalence class may have zero or more products. A manufacturer 501 manufacturers 530 zero or more products 504, and each product has exactly one manufacturer.

The characteristics of category 506, product family 508, and equivalence class 510 may be mapped to an incentive program 514 through the tables Category Incentive 518, Family Incentive 520, and Class Incentive 522 respectively. Thus when, for example a product 504 belongs to 544 a category 506, there may be a category incentive 518 for 550 the products of the category 506. If there is a category incentive for the product, the category incentive table maps 556 the product of that category to an incentive program 514.

The tables and relationships 520, 552, and 558 may map product families to incentive programs similar to the way categories were mapped with tables and relationships 518, 550 and 556. Similarly, equivalence class may map to the incentive programs by 522, 554, and 560. Each incentive program may have many categories, product families, and equivalence classes for which they would apply. Thus one incentive program in table 514, may apply to many different product categories 506, product families 508, and equivalence classes 510, or any combination thereof.

Once an incentive for a transaction has been determined, a manufacturer 501 may receive 532 the incentive designated by incentive program 514 that applies 540 to the transaction 512.

The above tables and architecture may be embodied in one or more relational databases of the type generally known in the art.

### Example Using Data Model of FIG. 5

The data model in FIG. 5 may be used to implement the processes described in FIG. 4. For example, to identify the manufacturer in step 303, the product 504 involved in the transaction 512 may be found through the “are sold” relationship 542. After finding the product, the manufacturer 501 of the product may be found through the “manufactures” relationship 530.

In 305, the manufacturer found in 303 may be compared to the seller in the transaction 512 using the relationship “sells” 538. If the user 516 works for 534 the manufacturer found in 303, we proceed to 307 without applying an incentive to the transaction.

If the seller was not determined to be the manufacturer in step 305, the process precedes to program 309, in which program blocks 401-409 may be run sequentially or in parallel.

The manufacturer incentive program 401 may determine the incentive program for a transaction based solely on the manufacturer of the product. The manufacturer 501 may be determined from a transaction using the same tables and relationships as step 303. An incentive program 514 may then be determined using the “receives” relationship 532. This relationship may find zero, one or many incentive programs that apply to the transaction. These incentive programs, or the highest priority program as determined by additional information, such as, but not limited to, the incentive program's start date, are passed on to program 411.

The manufacturer category incentive program 403 use the product category 506 as may be determined by the “belongs to” relationship 544 from the product as may be determined by the same process of step 303. All category incentives 550 matching the category, and mapping to 556 incentive programs 514 for which the manufacturer of the product receives 532 the incentive, may then determined. As before, the determined incentive program, or the highest priority program, are subsequently processed 411.

The manufacturer family incentive program 405 may uses the product family table 508 to determine zero or more incentive programs based on the product's family. The product's family may be found using the “belongs to” relationship 546. The incentive programs may then be determined by first using relationship 552 to determine the family incentive 520 and subsequently using relationship 558 to determine the matching incentive programs.

The manufacturer equivalence class program 407 uses a process similar to steps 403 and 405 to determine if there are more matching programs based on the equivalence class. Of course, additional incentive matching programs for block 409 may be set up.

The prioritization process 411 prioritizes incentive programs, such as for example 401-409, and may choose the incentive program with the highest priority. An incentive program's priority may be determined by a wide range of factors, including, but not limited to, assigning a specific priority number to an incentive program. In this example, we may assign priority based on the number of algorithms that determined the incentive program as a possible match for the transaction. We may choose the incentive program that the largest number of programs 401-409 determined may apply. Thus, if an incentive program was matched by the 3 of the programs 401, 403, and 407, it may have a higher priority than an incentive program matched by the 2 programs 401 and 405. If two or more incentive programs were determined by the same number of programs 401-405, then the priority process may choose the incentive program 514 with the more recent start date. If two or more programs still tie after that, the priority may choose the program that was most recently added to the database, as determined, for example, by an auto-incremented primary key attribute (not shown) of the incentive program. This auto-incremented primary key attribute is one way to implement a unique identifying attribute for a table, though there are many other ways to implement a unique identifier and final tiebreaker.

After prioritization 411, if no incentive program was selected 413, the process may terminate 307. If an incentive program was found at 413 then program 415 may modify the transaction in table 512 to indicate a relationship 540 between the incentive program and the transaction. Program 417 may then determine the actual incentive based on the incentive program found in block 309.

The following example illustrates one possible embodiment. In this example, the tables below are assumed to include the illustrated information. In some instances a unique primary key has been added to the tables of FIG. 5. For clarity, other tables not needed in this example have been omitted but may be discussed in the associated description.

Contents of Manufacturer 501

| Mfr Code | Mfr Name |
|---|---|
| ABC | ABC Manufacturing, Inc. |
| XYZ | XYZ Subsidiaries, Co. |

Contents of Product 504

| Mfr Code | Part Number | Name | Description |
|---|---|---|---|
| ABC | ABC-1234 | Foosball-XMJR | Foosball Xtreme JR. |
| ABC | ABC-7890 | Airhockey-XL | Air Hockey Table XL |
| XYZ | X-1122 | Super Pinball | Super pinball with anti-tilt |

Contents of Category 506

| Part Number | Category Name |
|---|---|
| ABC-1234 | Multiplayer Table |
| ABC-7890 | Multiplayer Table |
| X-1122 | Arcade |
| ABC-1234 | Dorm Equipment |
| ABC-7890 | Arcade |

Contents of Incentive Program 514

| | MfrCode | | Percent- | Percent- | | |
|---|---|---|---|---|---|---|
| ID | (receives) | Name | Profit | Revenue | DateStart | DateEnd |
| 5002 | ABC | ABC Dorms | 15% | 5% | 11 Jan. 2000 | NULL |
| 5003 | ABC | ABC General | 10% | 0% | 1 Jan. 1999 | 31 Dec. 2005 |
| 5004 | XYZ | XYZ Arcade | 0% | 7% | 1 Oct. 1998 | NULL |

Contents of Category Incentive 518

| Category Name | Incentive Program |
|---|---|
| Dorm Equipment | 5002 (ABC Dorms) |
| Arcade 5004 | (XYZ Arcade) |

Contents of User 516

| Name | Email | Address |
|---|---|---|
| User One | userone@ . . . | 123 Fake Street |
| User Two | usertwo@ . . . | 4321 Fake Street |

Contents of Transaction 512

| | Part- | | | | | Incentive |
|---|---|---|---|---|---|---|
| ID | Number | Quantity | Price | Buyer | Seller | Program |
| 9001 | ABC- | 100 | $456.78 | User One | User Two | NULL |
| | 1234 | | | | | |
| 9002 | ABC- | 20 | $123.45 | User One | User Two | NULL |
| | 7890 | | | | | |
| 9003 | X-1122 | 500 | $75.31 | User Two | User One | NULL |

### Explanation of Operation

In this database there are three transactions for which an incentive program has yet to be determined, transactions 9001, 9002, and 9003. The process for determining the incentive program that applies to each of the transactions, in this embodiment, is detailed below.

For transaction 9001, the part number is ABC-1234. Using the example data for 504, a determination is made that the products manufacturer is, “ABC Manufacturing, Inc.” by cross-referencing the MfrCode value for table 504 with the MfrCode value of table 501. Once the manufacturer for that product has been determined, incentive 401 may find all applicable incentive programs such as 5002 and 5003 in this example.

Program 403 may determine incentive programs matching by category, by cross-referencing table 504 and table 506, and may determine that ABC-1234 falls into the categories “Multiplayer Table” and “Dorm Equipment”. Program 403 may then cross-reference this data with table 518, and determine that the category “Dorm Equipment” matches incentive program 5002.

Programs 405, 407, and 409 may process the data similar to step 403. For clarity these processes have been omitted from the example data and processing in this example. However, it may be assumed for this example that 405, 407, and 409 did not match any incentive programs to the transaction.

At this point, 411 may now have enough information to decide which incentive program to apply to the transaction. Incentive program 5002 was matched twice, once by 401 and once by 403. Incentive program 5001 was matched only once, by 403. Thus program 5002, being matched the most in this example, is the incentive program that will be applied to the transaction, and 415 may change the value of the incentive program column of transaction 9001 in table 512 to 5002.

For transaction 9002, program 401 finds incentive programs 5002 and 5003. The category of the product ABC-7890 involved in this transaction is “Multiplayer Table.” This time, 403 does not match the category to any incentive programs. There may now have a tie between incentive programs 5002 and 5003, since they were both matched by exactly one incentive program block, namely 401. To break this tie, in this example, the start dates are examined which indicates that incentive program 5002 “ABC Table” started more recently. Therefore, in this example, incentive program 5002 is applied to transaction 9002.

For transaction 9003, program 401 finds incentive programs 5004 because the manufacturer of X-1122 is XYZ Subsidiaries, Co. The category of X-1122 is “Arcade” as found in the 506 example data. The Category Incentive table 518 example data matches categories “Arcade” to incentive programs 5004. Thus 5004 is determined by 2 incentive programs blocks (401 and 403), and since no other incentive matching programs have been found, 5004 is applied to transaction 9003.

Various embodiments have been described above that may enable a manufacturer to receive an incentive for goods and products the manufacturer produced that may be subsequently sold by other than the manufacturer. The software utilized in the various embodiments may execute on one or more suitable computing machines such as computer 601. Examples of such machines 601 include, but are not limited to, mainframes, workstations, desktop computers and portable computers. The seller 201, buyer 209 and manufacturer 501, in some embodiments, may communicate with computer 601 using we World Wide Web. The computer(s) 601 may be coupled to one or more storage devices 609. Storage devices 609 may include hard disk drives, floppy disk drives, compact disk drives, solid state memory, magnetic memory, or other storage devices. In addition, computer 601 may include data base software 611 and Imarket software 613 that may include programs 205 and 207.

While it may be advantageous for the sellers and buyers to be able to access and utilize the software over the World Wide Web, other communication methods may be advantageously utilized. As one example, either or both the seller and buyer may access a dial-up computer. Additionally, the selling and buying information may be manually entered into the appropriate data base or other software.

In addition, while embodiments have been described above where the manufacturer may not receive an incentive when the manufacturer is the seller, other embodiments are also possible. For example, the manufacturer may receive an incentive for all sales of goods or products manufactured by the manufacturer regardless of the seller.

While certain features of the invention have been illustrated and described herein, many modifications, substitutions, changes, and equivalence will now occur to those of ordinary skill in the art. It is, therefore, to be understood that the appended claims are intended to cover all such modifications and changes has fall within the true spirit of the invention.

We claim:

1. A computer-implemented method for the purchase and sale of products by purchasers and sellers, comprising:
storing in computer storage information on a product for sale, the information including, an identification of the manufacturer of the product;
determining the product was purchased;
calculating by the computer a manufacturer incentive to the manufacturer of the purchased product; and
paying the manufacturer incentive to the manufacturer if the manufacturer was not the seller of the product.

2. The computer-implemented process of claim 1, wherein the incentive is a percentage of a purchase price of the purchased product.

3. The computer-implemented process of claim 1, wherein the incentive is a percentage of a profit from the sale of the product.

4. The computer-implemented process of claim 1, wherein the manufacturer incentive is computed, in part, according to a product attribute.

5. The computer-implemented process of claim 4, wherein the product attribute is a product category.

6. The computer-implemented process of claim 4, wherein the product attribute is a product name.

7. The computer-implemented process of claim 4, wherein the product attribute is a product family.

8. The computer-implemented process of claim 4, wherein the product attribute is an identification of an equivalent product.

9. The computer-implemented process of claim 4, wherein the product attribute is a product date code.

10. The computer-implemented process of claim 1, wherein said calculating comprises employing one of a plurality of computer incentive programs to calculate said incentive, each such program having criteria specific to a corresponding product.

11. The computer-implemented process of claim 10 further comprising selecting by said computer a one of said plurality of computer incentive programs having a priority for calculating the incentive.

12. The computer-implemented process of claim 1, the incentive is based, in part, on a sale transaction.

13. The computer-implemented process of claim 12 including the step of adjusting the incentive as a function of a plurality of factors.

14. The computer-implemented process of claim 13, wherein the plurality of factors includes the type of transaction.

15. A computer-implemented method for enabling purchasers to buy products that are for sale, comprising:
listing in computer storage products that are for sale;
listing in computer storage the seller of the products;
listing in computer storage the manufacturer of the products;
purchasing at least one of the listed products;
calculating by the computer a manufacturer incentive to the manufacturer of the purchased product; and
paying the manufacturer incentive to the manufacturer if the manufacturer was not the seller of the product.

16. The computer-implemented process of claim 15 wherein the incentive is a percentage of the purchase price of the purchased products.

17. The computer-implemented process of claim 15 wherein the incentive is a percentage of the profit from the sale of the purchased products.

18. The computer-implemented process of claim 15 wherein the manufacturer incentive is computed, in part, according to a product attribute.

19. The computer-implemented process of claim 18 wherein the product attribute is a product category.

20. The computer-implemented process of claim 18 wherein the product attribute is a product name.

21. The computer-implemented process of claim 18 wherein the product attribute is product family.

22. The computer-implemented process of claim 18 wherein the product attribute is a equivalent product.

23. The computer-implemented process of claim 18 wherein the product attribute is product date code.

24. The computer-implemented process of claim 15 wherein there are a plurality of computer incentive programs to calculate the incentive, each such program having an individual priority.

25. The computer-implemented process of claim 24 including the step of determining by computer comparison the computer incentive program having the highest priority for calculating the incentive.

26. The computer-implemented process of claim 15, the incentive is based, in part, on a sale transaction.

27. The computer-implemented process of claim 26 including the step of adjusting the incentive as a function of a plurality of factors.

28. The computer-implemented process of claim 27 wherein the plurality of factors includes the type of transaction.

29. A computer system for tracking transactions of goods between parties that are not themselves the manufacturer of the goods and calculating incentives to be paid to the manufacturer based on those transactions.

30. The computer system of claim 29 wherein the incentive is a percentage of the revenue from the transaction.

31. The computer system of claim 30 wherein the percentage of revenue is calculated using a purchase price for the transaction that is set by auction.

32. The computer system of claim 29 wherein the incentive is a percentage of the profit from the transaction.

33. The computer system of claim 32 in which the percentage from of the profit is calculated, in part, using a purchase price for the transaction that is set by auction.

34. The computer system of claim 29 wherein the incentive is a fixed fee.

35. The computer system of claim 29 wherein the incentive is a discount.

36. A computer program, stored on a computer readable medium, that when read by a computer, causes the computer to:
store in computer storage a listing of products that are for sale;
store in computer storage an identification of the seller of the products;
store in computer storage the manufacturer of the products;
purchasing at least one of the listed products;
calculating by the computer a manufacturer incentive to the manufacturer of the purchased product; and
paying the manufacturer incentive to the manufacturer if the seller was not the manufacturer.

37. The computer program of claim 36 wherein the incentive is calculated as percentage of the revenue from the transaction.

38. The computer program of claim 36 wherein the incentive is calculated using a price set by auction.

39. The computer program of claim 36 wherein the incentive is calculated as a percentage of the profit from the transaction.

40. The computer program of claim 36 wherein the computer calculation function calculates the incentive using a price set by auction.

41. The computer program of process of claim 36 wherein the incentive is a fixed fee.

42. The computer-implemented process of claim 36 wherein the incentive is a discount.
